(19) United States
(12) Patent Application Publication
(10) Pub. No.: US 2025/0052643 A1
(43) Pub. Date: Feb. 13, 2025

(54) SOUND ABSORPTION AND ISOLATION MODULE FOR TIRE NOISE REDUCTION AND AN OPERATION APPARATUS THEREOF

(71) Applicants: HYUNDAI MOTOR COMPANY, Seoul (KR); KIA CORPORATION, Seoul (KR)

(72) Inventors: Ki Won Park, Yongin-si (KR); Sung Yong Cho, Incheon (KR)

(73) Assignees: HYUNDAI MOTOR COMPANY, Seoul (KR); KIA CORPORATION, Seoul (KR)

(21) Appl. No.: 18/507,968

(22) Filed: Nov. 13, 2023

(30) Foreign Application Priority Data
Aug. 11, 2023 (KR) 10-2023-0105468

(51) Int. Cl. G01M 17/007

(52) U.S. Cl. CPC G01M 17/0074

(57) ABSTRACT

A sound absorption and isolation module is configured to reduce noise radiated from a tire and an operation apparatus thereof. The sound absorption and isolation module is formed by integrally combining a box outer plate, a sound isolation sheet, a sound absorption material, and a pad member. The sound absorption and isolation module is used to reduce the noise radiated from the tire and generated during a roll-and-brake process.

### CROSS-REFERENCE TO THE RELATED APPLICATION

This application claims priority to Korean Patent Application No. 10-2023-0105468, filed on Aug. 11, 2023, in the Korean Intellectual Property Office, the disclosure of which is incorporated herein by reference in its entirety.

### FIELD OF THE DISCLOSURE

The present disclosure relates to a sound absorption and isolation module configured to reduce noise radiated from a tire and relates to an operation apparatus thereof. More particularly, the present disclosure relates to a sound absorption and isolation module configured to reduce noise generated from a tire during a roll-and-brake process and an operation apparatus thereof.

### BACKGROUND

A roll-and-brake test system, which is one of various known vehicle test systems, is configured to provide vehicle quality assurance in an inline process.

The roll-and-brake test system may test vehicle errors, assembly performance, acceleration performance, and brake performance by implementing driving conditions similar to situations occurring on the road.

When a vehicle to be tested enters the roll-and-brake test system, tires of the vehicle to be tested are located on rollers of the test system. Thereafter, a tester enters the vehicle to be tested and performs a test while sequentially performing acceleration, natural deceleration, neutral, braking, and stopping operations.

Meanwhile, when a roll-and-brake test is performed, radiated noise is significantly generated from a tire. Here, the radiated noise is caused by rotation of a roller and a tire. Accordingly, in order to prevent the noise radiated from the tire from escaping to the outside, a soundproof booth is installed to perform a roll-and-brake process therein.

However, there is a disadvantage in that excessive investment costs are necessary to install the soundproof booth. Particularly, the health of workers working in the soundproof booth may be threatened, and as such work efficiency in the soundproof booth may deteriorate.

The information disclosed in this Background section is only to enhance understanding of the general background of the present disclosure. The Background section should not be taken as an acknowledgement or any form of suggestion that this information forms the related art already known to a person having ordinary skill in the art.

### SUMMARY

Therefore, the present disclosure has been made in view of the above problems. It is an object of the present disclosure to provide a sound absorption and isolation module configured to reduce noise radiated from a tire and generated during a roll-and-brake process by covering only a portion of a vehicle in a chamber. In the chamber, the portion has a tire mounted thereon and the vehicle enters a roll-and-brake test system. The present disclosure also provides an operation apparatus thereof. According to the present disclosure, since a soundproof booth is not installed, it is possible not only to reduce costs but also to reduce the scale of a work process. Particularly, since a worker does not perform a test in the soundproof booth, the worker's health may not be threatened, and work efficiency may be improved.

In accordance with an aspect of the present disclosure, the above and other objects can be accomplished by providing a sound absorption and isolation module configured to reduce noise radiated from a tire. The sound absorption and isolation module includes a box outer plate configured to form an outer shape of the sound absorption and isolation module and a skeleton of the sound absorption and isolation module. The module also includes a sound isolation sheet coupled to an inner surface of the box outer plate. The module also includes a sound absorption material coupled to an inner surface of the sound isolation sheet.

The box outer plate may be made of aluminum to prevent the noise from escaping to an outside of the sound absorption and isolation module.

The sound isolation sheet may be formed of a thermoplastic material to prevent the noise from escaping to an outside thereof.

The sound absorption material may be formed of a polyurethane material to absorb and reduce the noise.

The sound absorption material may have a convex protrusion formed over an entire area of the sound isolation sheet and configured to increase a sound absorption effect.

The sound isolation sheet and the sound absorption material may be provided with a cushioning function to increase a sound absorption and isolation effect.

The noise may be generated from the tire when the tire is inserted into an inner space of the sound absorption material and is rotated therein. The noise may be firstly reduced by being absorbed through the sound absorption material. The noise may be secondly reduced through the sound isolation sheet and the box outer plate.

The sound absorption and isolation module may further include a handle coupled to the box outer plate.

The sound absorption and isolation module may further include a pad member coupled along an edge of one side surface of the box outer plate. The pad member may be configured to prevent the noise generated from the tire from leaking to an outside of the pad member by contacting a vehicle body around the tire.

The sound absorption and isolation module may be formed by integrally combining the box outer plate, the sound isolation sheet, the sound absorption material, and the pad member. The sound absorption and isolation module may cover all of the tires of a vehicle entering a roll-and-brake process in a one-to-one correspondence manner so as to reduce the noise generated when the tires are rotated.

In accordance with another aspect of the present disclosure, an operation apparatus of a sound absorption and isolation module configured to reduce noise radiated from a tire is provided. The operation apparatus includes a cylinder module connected to the sound absorption and isolation module. The cylinder module is configured to move, during operation of the cylinder module, the sound absorption and isolation module toward a side surface of a vehicle entering a roll-and-brake process. The operation apparatus also includes a base having the cylinder module coupled to the base. The operation apparatus also includes a guide coupled to the base and formed to extend in a forward-and-rearward direction of the vehicle so as to guide movement of the base. The operation apparatus also includes a motor configured to provide power for the movement of the base.

The sound absorption and isolation module may have a hinge connected thereto so as to be rotatable with respect to the cylinder module.

The sound absorption and isolation module may be located in a rearward movement state when the vehicle to be tested enters the roll-and-brake process, so as to allow the vehicle to enter a test position. After the vehicle completely enters the test position and the tire is located on a roller, the sound absorption and isolation module may move forwards by the operation of the cylinder module and cover the tire while contacting a vehicle body around the tire.

The cylinder module may include a first cylinder fixed to the base. The cylinder module may also include a second cylinder connected to a first rod of the first cylinder and configured to move in a longitudinal direction of the first cylinder when the first cylinder is operated. The second cylinder may have a second rod connected to a head part having a function of reducing the noise. The head part may contact, when the second cylinder is operated, one side of the tire located on a roller in the roll-and-brake process.

The head part may move, when the tire is rotated to move to one side of the roller and the other side thereof, with the tire in a state of contacting the tire, so as to reduce the noise.

### BRIEF DESCRIPTION OF THE DRAWINGS

The above and other objects, features, and other advantages of the present disclosure should be more clearly understood from the following detailed description taken in conjunction with the accompanying drawings, in which:

FIG. 1 is a diagram showing a sound absorption and isolation module according to the present disclosure;

FIG. 2 is a front view of FIG. 1;

FIG. 3 is a diagram showing a state in which a pad member is removed in FIG. 2;

FIG. 4 is a diagram showing a convex protrusion formed on a sound absorption material; and

FIGS. 5-10 are diagrams showing an operation apparatus of the sound absorption and isolation module according to the present disclosure.

### DETAILED DESCRIPTION

Reference is now made in detail to embodiments of the present disclosure, examples of which are illustrated in the accompanying drawings. Wherever possible, the same reference numbers are used throughout the drawings to refer to the same or like parts, and redundant descriptions thereof have been omitted.

Hereinafter, suffixes “module”, “unit”, and “part” for components used in the following description are merely provided for facilitation of preparing this specification. Therefore, significant meanings or roles are not given to the suffixes themselves.

In describing the embodiments disclosed herein, where it has been determined that the detailed description of publicly known techniques to which the present disclosure pertains may have obscured the gist of the present disclosure, the detailed description has been omitted.

Further, it should be understood that the accompanying drawings are merely illustrated to easily describe the embodiments disclosed in the present disclosure. Therefore, the technical idea disclosed in the present disclosure is not limited by the accompanying drawings. Further, it should be noted that the accompanying drawings include all modifications, equivalents, and substitutes that fall within the spirit and technical scope of the present disclosure.

Meanwhile, in the present disclosure, terms such as “first” and/or “second” may be used to describe various components, but the components are not limited by the terms. The terms are used only for the purpose of distinguishing one component from other components.

When one component is referred to as being “connected” or “joined” to another component, the one component may be directly connected or joined to the other component, but it should be understood that other components may be present therebetween.

On the other hand, when the one component is referred to as being “directly connected to” or “directly in contact with” the other component, it should be understood that no other components are present therebetween.

In this specification, an expression in a singular form also includes the plural sense, unless clearly specified otherwise in context.

It should be understood that expressions, such as “comprise” and “have” in the present disclosure, are intended to designate the presence of indicated features, numbers, steps, operations, components, parts, or combinations thereof. However, these expressions do not exclude the presence or addition of one or more features, numbers, steps, operations, components, parts, or combinations thereof.

In addition, a unit or a control unit included in the names of a motor control unit (MCU), a hybrid control unit (HCU), or the like is a term widely used to refer to a control apparatus (controller) configured to control a specific vehicle function and does not mean a general functional unit.

In order to control various functions, a controller may include a communication apparatus configured to communicate with another controller or a sensor, a memory configured to store an operating system, a logical command, and input/output information, and one or more processors configured to perform determination, calculation, and the like necessary to control a corresponding function. When a component, device, element, or the like of the present disclosure is described as having a purpose or performing an operation, function, or the like, the component, device, element, or the like should be considered herein as being “configured to” meet that purpose or to perform that operation or function. Each of the component, device, element, and the like may separately embody or be included with a processor and a memory, such as a non-transitory computer readable media, as part of the apparatus.

Hereinafter, a description is given as to a sound absorption and isolation module configured to reduce noise radiated from a tire and an operation apparatus thereof according to an embodiment of the present disclosure with reference to the accompanying drawings.

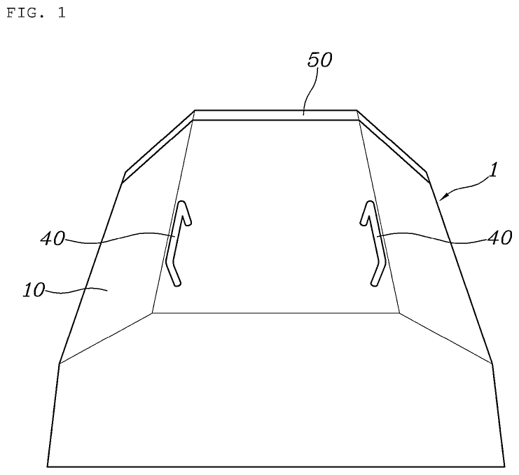

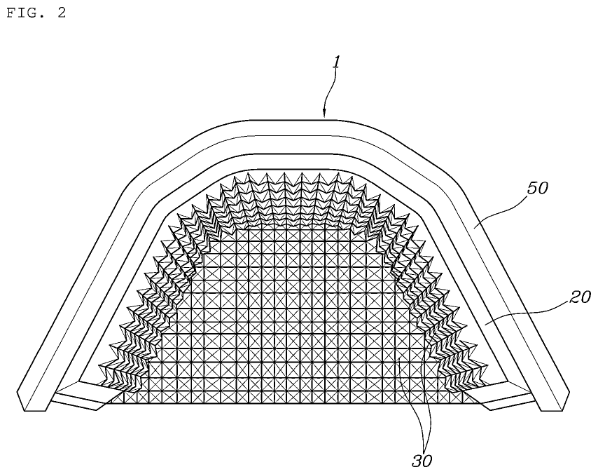

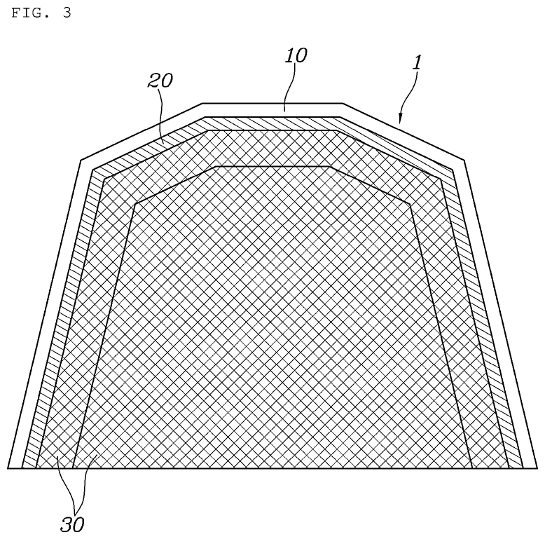

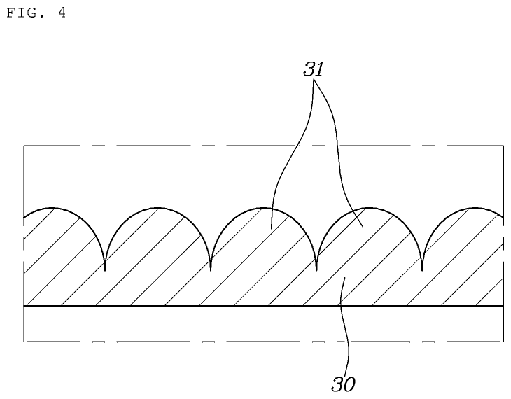

As shown in FIGS. 1-4, a sound absorption and isolation module 1 according to the present disclosure is installed in a roll-and-brake test system, which is one of various vehicle test systems. The sound absorption and isolation module 1 has a function of reducing noise radiated from a tire and generated during a roll-and-brake process by covering the tire of a vehicle located at a test position.

In other words, as shown in the drawings, the sound absorption and isolation module 1 is configured to reduce the noise radiated from the tire according to the present disclosure. The sound absorption and isolation module 1 includes a box outer plate 10 forming the outer shape of the sound absorption and isolation module 1 and forming the skeleton of the sound absorption and isolation module 1. The sound absorption and isolation module 1 also includes a sound isolation sheet 20 coupled to the inner surface of the box outer plate 10. The sound absorption and isolation module 1 also includes a sound absorption material 30 coupled to the inner surface of the sound isolation sheet 20.

The box outer plate 10 is made of aluminum and has a cross-sectional thickness of 3 mm. Further, the box outer plate 10 serves not only to maintain the outer frame of the sound absorption and isolation module 1 but also to prevent noise from escaping to the outside thereof.

The sound isolation sheet 20 is coupled to the inner side of the box outer plate 10, is formed of a polyvinyl chloride (PVC) thermoplastic material, and has a cross-sectional thickness of 3 mm. As in the case of the box outer plate 10, the sound isolation sheet 20 serves as a sound isolation member configured to prevent noise from escaping to the outside thereof.

The sound absorption material 30 is coupled to the inner side of the sound isolation sheet 20 and is made of polyurethane. Further, the sound absorption material 30 has a cross-sectional thickness of 75 mm and serves to absorb and reduce noise.

The sound absorption material 30 may have a structure in which a convex protrusion 31 is formed over the entire area of the sound absorption material 30 to increase a sound absorption effect.

The convex protrusion 31 may be formed in various shapes, such as a circular arc protrusion shape or a triangular protrusion shape.

In addition, the sound isolation sheet 20 and the sound absorption material 30 according to the present disclosure may have a cushioning function to increase a sound absorption d isolation effect, without being limited thereto.

In the embodiment according to the present disclosure, when the roll-and-break process is performed, a tire of a vehicle to be tested is covered with the sound absorption and isolation module 1 so as to allow the tire to be inserted into and positioned in the inner space of the sound absorption material 30. Accordingly, when radiated noise is generated due to rotation of the tire, the noise is absorbed through the sound absorption material 30 and is firstly reduced. Continuously, the noise is secondly reduced while passing through the sound isolation sheet 20 and the box outer plate 10. Thus, the noise radiated from the tire may be significantly reduced.

In the noise radiated from the tire and generated during the roll-and-brake process, noise energy absorbed and isolated through the sound absorption material 30, the sound isolation sheet 20, and the box outer plate 10 is converted into thermal energy and dissipated inside. Meanwhile, only some of the remaining noise (leakage sound) that is not absorbed and isolated leaks to the outside. Thus, the noise radiated from the tire and generated during the roll-and-brake process may be significantly reduced.

Therefore, in the embodiment according to the present disclosure, there is an advantage in that it is not necessary to install a bulky and expensive soundproof booth in the place where the roll-and-break process is performed. Through this configuration, it is possible not only to reduce costs but also to reduce the scale of a work process. Particularly, since a worker does not perform a test in the soundproof booth, the worker's health may not be threatened, and work efficiency may be improved.

The sound absorption and isolation module 1 according to the present disclosure may further include a plurality of handles 40 formed to protrude outwards from the outer surface of the box outer plate 10.

The handle 40 may be made of a steel material to secure rigidity thereof but is not limited thereto.

In addition, the sound absorption and isolation module 1 according to the present disclosure may further include a pad member 50 coupled along the edge of one side surface of the box outer plate 10 and configured to prevent noise generated from a tire from leaking to the outside by contacting a vehicle body (a garnish) around the tire.

The pad member 50 may be formed of a rubber material or a silicone material to prevent damage to the vehicle body when the pad member 50 is in contact with the vehicle body and to maximize the effect of preventing noise from leaking to the outside. However, the benefits of the pad member 50 are not limited thereto.

The sound absorption and isolation module 1 according to the present disclosure is formed by integrally combining the box outer plate 10, the sound isolation sheet 20, the sound absorption material 30, and the pad member 50. The sound absorption and isolation module 1 according to the present disclosure serves to reduce noise generated during rotation of a tire by covering all the tires of a vehicle to be tested when the vehicle enters a roll-and-brake process in a one-to-one correspondence manner.

The sound absorption and isolation module 1 according to the present disclosure may effectively reduce both high-frequency noise and low-frequency noise generated from a tire.

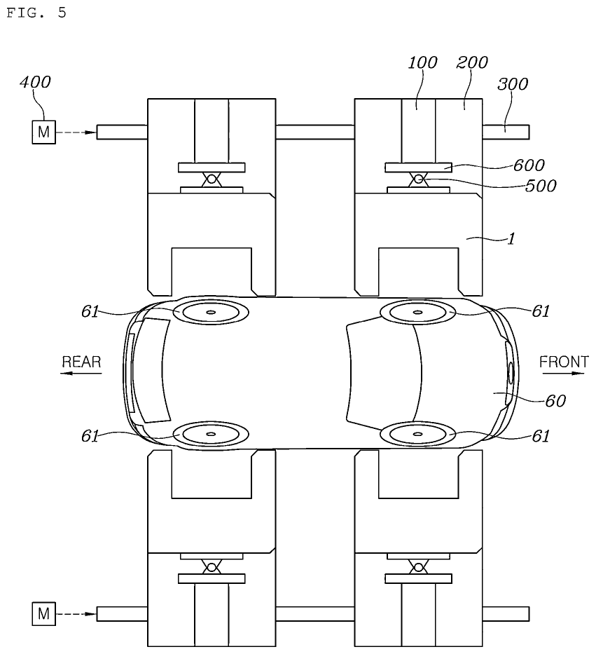

Hereinafter, an operation apparatus of the sound absorption and isolation module according to the present disclosure is described with reference to FIGS. 5-10.

As shown in the drawing, the operation apparatus according to the present disclosure includes a cylinder module 100 connected to the sound absorption and isolation module 1 and configured to move, during operation thereof, the sound absorption and isolation module 1 toward the side surface of a vehicle 60 entering the roll-and-brake process. The operation apparatus also includes a base 200 having the cylinder module 100 coupled thereto. The operation apparatus also includes a guide 300 coupled to the base 200 and formed to extend in the forward-and-rearward direction of the vehicle 60 so as to guide movement of the base 200. The operation apparatus also includes a motor 400 configured to provide power for movement of the base 200.

According to the present disclosure, the sound absorption and isolation module 1 may have a hinge 500 connected thereto so as to be rotatable with respect to the cylinder module 100.

Specifically, the cylinder module 100 may be coupled to a cylinder block 600, and the cylinder block 600 and the sound absorption and isolation module 1 may be connected to each other using the hinge 500.

An automation system configured to control the operation of the sound absorption and isolation module 1 may be controlled in two directions. First, in the case of the forward-and-rearward direction, which is the longitudinal direction of the guide 300, in order to respond to multiple types of vehicles, forward-and-rearward movement of the sound absorption and isolation module 1 may be controlled through the guide 300 so as to match the vehicle width.

Further, movement in the left-and-right direction (left-and-right movement) of the sound absorption and isolation module 1 may be controlled by the operation of the cylinder module 100.

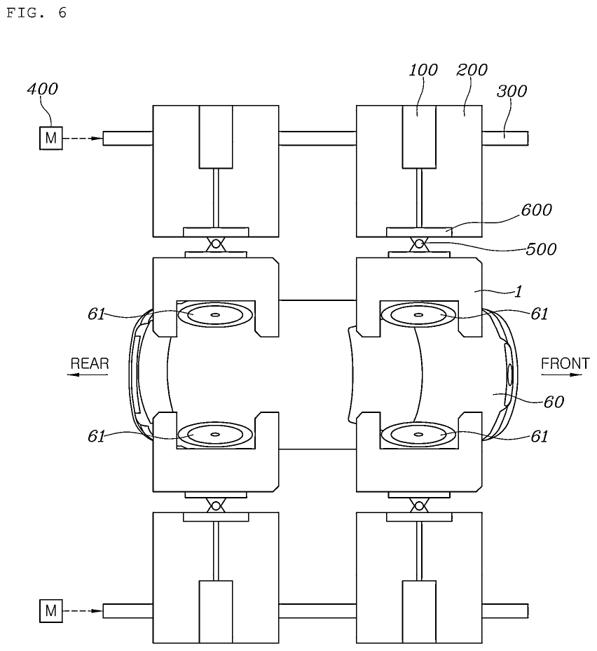

In other words, when a vehicle to be tested enters the roll-and-brake process, the sound absorption and isolation module 1 is located in the rearward movement state, as shown in FIG. 5, and thus the vehicle is allowed to enter the test position. Then, as shown in FIG. 6, when the vehicle enters the test position and a tire 61 is positioned on a roller 70, the sound absorption and isolation module 1 moves forwards by the operation of the cylinder module 100 and contacts the vehicle body around the tire 61. In this case, the left-and-right movement (the forward-and-rearward movement) of the sound absorption and isolation module 1 may be controlled so as to cover the tire 61.

Further, as shown in FIG. 6, the operation of the cylinder module 100 causes the sound absorption and isolation module 1 to move forwards and contact the vehicle body around the tire 61. In this state, the sound absorption and isolation module 1 may have the hinge 500 connected thereto so as to cope with shaking generated when the vehicle is driven.

The cylinder module 100 according to the present disclosure includes a first cylinder 110 fixed to the base 200. The cylinder module 100 also includes a second cylinder 120 connected to a first rod 111 of the first cylinder 110 and configured to move in the longitudinal direction of the first cylinder 110 when the first cylinder 110 is operated. Here, the second cylinder 120 has a second rod 121 connected to a head part 80 having a function of reducing noise. The head part 80 may reduce noise by contacting one side of the tire 61 located on the roller 70 in the roll-and-brake process when the second cylinder 120 is operated.

The head part 80 may be formed of a material capable of absorbing or isolating noise. For example, the head part 80 may be formed of a PVC thermoplastic material such as the sound isolation sheet 20 or a polyurethane material such as the sound absorption material 30.

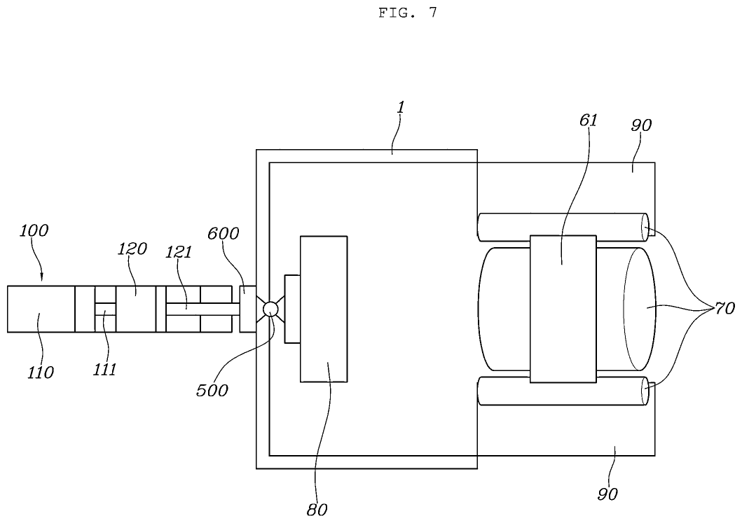

In FIG. 7, reference numeral 90 denotes a roller cover.

When the vehicle to be tested enters the roll-and-brake process, as shown in FIG. 7, the sound absorption and isolation module 1 and the head part 80 may be positioned in the rearward movement state so as to allow the vehicle to enter the test position.

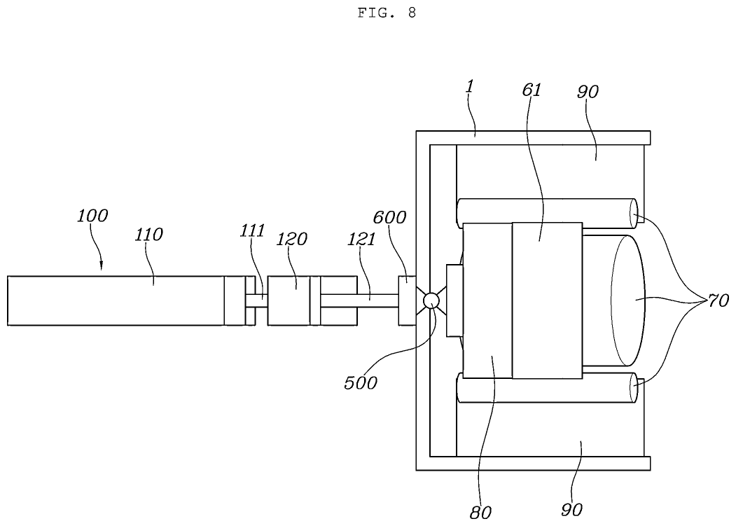

Thereafter, when the vehicle entry into the test position is completed and the tire 61 is located in the center of the roller 70, the operation of the first cylinder 110 causes the second cylinder 120, the sound absorption and isolation module 1, and the head part 80 to move forwards, as shown in FIG. 8. Then, the sound absorption and isolation module 1 covers the tire 61, and the head part 80 is in a state of contacting one surface of the tire 61. In this state, noise generated when the tire 61 is rotated is absorbed and isolated by the sound absorption and isolation module 1 and the head part 80. Thus, the noise may be significantly reduced.

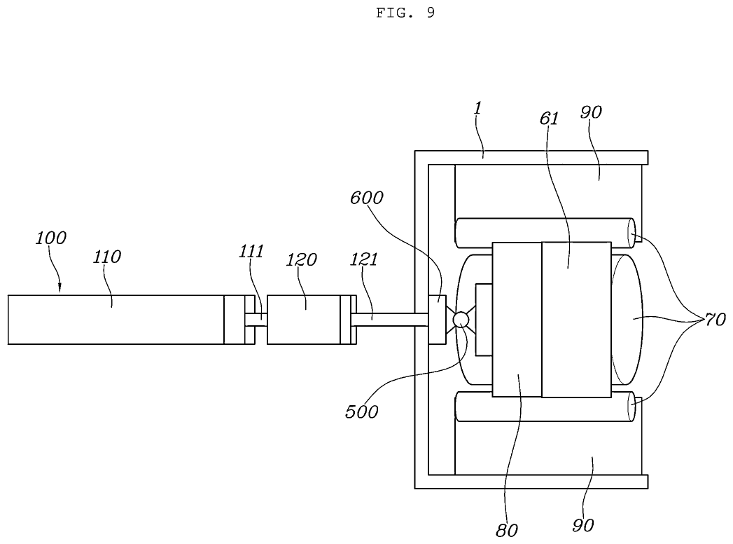

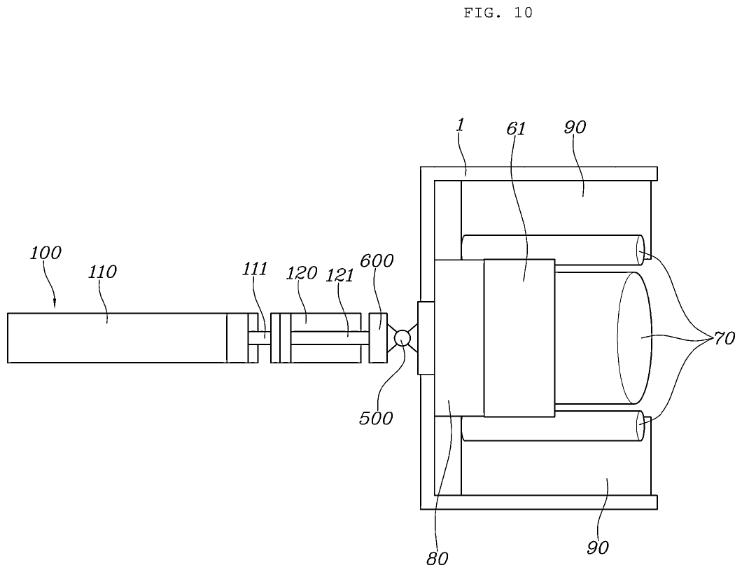

In addition, the tire 61 is rotated, and tire dispersion occurs. Here, when the tire 61 moves to one side of the roller 70 and the other side thereof, as shown in FIGS. 9 and 10, the head part 80 maintains a state of contacting one surface of the tire 61 by the operation of the second cylinder 120, and the head part 80 moves with the tire 61 in a state of contacting one surface of the tire 61. Thus, the noise may be reduced.

As described above, in the embodiment according to the present disclosure, the sound absorption and isolation module 1 is formed by integrally combining the box outer plate 10, the sound isolation sheet 20, the sound absorption material 30, and the pad member 40. Further, the sound absorption and isolation module 1 is configured to cover the tire 61 of the vehicle to be tested 60 and to reduce noise radiated from the tire 61 and generated during the roll-and-brake process. Accordingly, there is an advantage in that it is not necessary to install a bulky and expensive soundproof booth. Through this configuration, it is possible not only to reduce costs but also to reduce the scale of a work process. Particularly, since a worker does not perform a test in the soundproof booth, the worker's health may not be threatened, and work efficiency may be improved.

As is apparent from the above description, the present disclosure provides a sound absorption and isolation module formed by integrally combining a box outer plate, a sound isolation sheet, a sound absorption material, and a pad member. The sound absorption and isolation module is configured to cover a tire of a vehicle to be tested and to reduce noise radiated from the tire and generated during a roll-and-brake process. Accordingly, it is not necessary to install a bulky and expensive soundproof booth to reduce the noise radiated from the tire. Through this configuration, it is possible not only to reduce costs but also to reduce the scale of a work process. Particularly, since a worker does not perform a test in the soundproof booth, the worker's health may not be threatened, and work efficiency may be improved.

Although the embodiments of the present disclosure have been disclosed for illustrative purposes, those having ordinary skill in the art should appreciate that various modifications, additions, and substitutions are possible, without departing from the scope and spirit of the present disclosure as disclosed in the accompanying claims.

What is claimed is:

1. A sound absorption and isolation module configured to reduce noise radiated from a tire, the sound absorption and isolation module comprising:
a box outer plate configured to form an outer shape of the sound absorption and isolation module and form a skeleton of the sound absorption and isolation module;
a sound isolation sheet coupled to an inner surface of the box outer plate; and
a sound absorption material coupled to an inner surface of the sound isolation sheet.

2. The sound absorption and isolation module according to claim 1, wherein the box outer plate is made of aluminum to prevent the noise from escaping to an outside thereof.

3. The sound absorption and isolation module according to claim 1, wherein the sound isolation sheet is formed of a thermoplastic material to prevent the noise from escaping to an outside of the sound isolation sheet.

4. The sound absorption and isolation module according to claim 1, wherein the sound absorption material is formed of a polyurethane material to absorb and reduce the noise.

5. The sound absorption and isolation module according to claim 1, wherein the sound absorption material has a convex protrusion formed over an entire area of the sound absorption material and configured to increase a sound absorption effect.

6. The sound absorption and isolation module according to claim 1, wherein the sound isolation sheet and the sound absorption material are provided with a cushioning function to increase a sound absorption and isolation effect.

7. The sound absorption and isolation module according to claim 1, wherein the noise is generated from the tire when the tire is inserted into an inner space of the sound absorption material and is rotated therein, wherein the noise is firstly reduced by being absorbed through the sound absorption material, and wherein the noise is secondly reduced through the sound isolation sheet and the box outer plate.

8. The sound absorption and isolation module according to claim 1, further comprising a handle coupled to the box outer plate.

9. The sound absorption and isolation module according to claim 1, further comprising a pad member coupled along an edge of one side surface of the box outer plate, the pad member configured to prevent the noise generated from the tire from leaking to an outside of the pad member by contacting a vehicle body around the tire.

10. The sound absorption and isolation module according to claim 9, wherein:
the sound absorption and isolation module is formed by integrally combining the box outer plate, the sound isolation sheet, the sound absorption material, and the pad member; and
the sound absorption and isolation module covers all of the tires of a vehicle entering a roll-and-brake process in a one-to-one correspondence manner so as to reduce the noise generated when the tires are rotated.

11. An operation apparatus of a sound absorption and isolation module configured to reduce noise radiated from a tire, the operation apparatus comprising:
a cylinder module connected to the sound absorption and isolation module and configured to move, during operation of the cylinder module, the sound absorption and isolation module toward a side surface of a vehicle entering a roll-and-brake process;
a base having the cylinder module coupled to the base;
a guide coupled to the base and formed to extend in a forward-and-rearward direction of the vehicle so as to guide movement of the base; and
a motor configured to provide power for the movement of the base.

12. The operation apparatus according to claim 11, wherein the sound absorption and isolation module has a hinge connected thereto so as to be rotatable with respect to the cylinder module.

13. The operation apparatus according to claim 11, wherein:
the sound absorption and isolation module is located in a rearward movement state when the vehicle to be tested enters the roll-and-brake process, so as to allow the vehicle to enter a test position; and
after the vehicle completely enters the test position and the tire is located on a roller, the sound absorption and isolation module moves forwards by the operation of the cylinder module and covers the tire while contacting a vehicle body around the tire.

14. The operation apparatus according to claim 11, wherein the cylinder module comprises:
a first cylinder fixed to the base; and
a second cylinder connected to a first rod of the first cylinder and configured to move in a longitudinal direction of the first cylinder when the first cylinder is operated,
wherein the second cylinder includes a second rod connected to a head part having a function of reducing the noise, and
wherein the head part contacts, when the second cylinder is operated, one side of the tire located on a roller in the roll-and-brake process.

15. The operation apparatus according to claim 14,
wherein the head part moves, when the tire is rotated to move to one side of the roller and the other side of the roller, with the tire in a state of contacting the tire, so as to reduce the noise.
